(19) United States
(12) Patent Application Publication
(10) Pub. No.: US 2019/0364851 A1
(43) Pub. Date: Dec. 5, 2019

(54) Fanny Pack for a Dog with Accessory Holders

(71) Applicant: Michelle Deluya, Canoga Park, CA (US)

(72) Inventor: Michelle Deluya, Canoga Park, CA (US)

(21) Appl. No.: 15/994,981

(22) Filed: May 31, 2018

(51) Int. Cl. A01K 27/00

(52) U.S. Cl. CPC A01K 27/008; A01K 27/002

(57) ABSTRACT

A dog harness, has a main body, formed of a material having a front section, a back section, a first leg opening, and a second leg opening. The top portion of the main body has a center opening, a first extending section overlapping with a second extending section and separable from said second extending section, and a connection section, which connects between the first extending section and the second extending section and holding the first extending section relative to the second extending section and also allowing disconnection between the first extending section and the second extending section. A pocket extends above a surface of the first extending section, and having an interior cavity, and the pocket having a slot at a top section thereof, the slot being effective to allow dispensing dog waste bags through a surface of the pocket without opening the flap closing the pocket.

This application claims priority from provisional application No. 62/515,388, filed Jun. 5, 2017, the entire contents of which are herewith incorporated by reference.

### BACKGROUND

It is essential to have a waste bag when walking a dog. Forgetting to equip yourself with a waste bag during dog walking can be embarrassing. The inventor recognized an efficient solution.

### SUMMARY

The present invention describes a dog harness, called the “K-9 Fanny Pack” that is equipped to carry waste bags, for a well planned dog walking experience. The harness has a pocket that carries dog waste bags, and can dispense those bags through a slot in the pocket.

By using this special harness, a dog walker never forgets the bags when taking the dog on a walk. This is because the bags are attached to the harness and do not need to be taken separately. The pocket with waste bags is refillable.

In addition, this harness is very easy to use. The harness is a step-in harness, making it easier to put on the dog. Once stepped in, the harness includes a wide grip Velcro fastener that can adjust to the dog's size and comfort. The adjustment allows for changes in the dog's size. Also, the harness has bindings at the edges, and those bindings are reflective, to make the harness easier to use at night.

The harness also has a D-ring that can attach to a leash, avoiding the need to put a separate collar on the dog in addition to the harness.

### BRIEF DESCRIPTION OF THE DRAWINGS

In the Drawings:

FIG. 1 shows a bottom view of the harness;

FIG. 2 shows a top view of the harness; and

FIG. 3 shows a close up view of the pocket that is located on the harness.

### DETAILED DESCRIPTION

Embodiments describe a dog harness called the K-9 fanny pack, that is an easy-to use step in harness, that also includes a dog waste bag dispenser, making it much easier to equip and walk your dog. The Velcro fastener can be tightened and loosened to adjust to different size dogs.

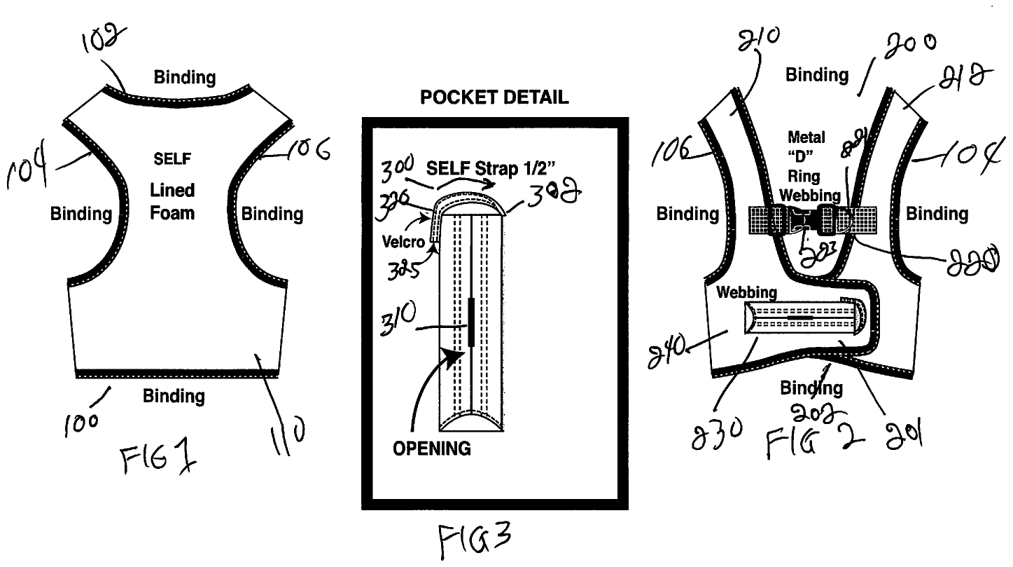

An embodiment is shown in FIGS. 1 and 2, where FIG. 1 shows the embodiment from the bottom and FIG. 2 shows the embodiment from the top. In the embodiment, all of the edges are covered with bindings, which are edge spots that are covered with additional material to reinforce those edges. That binding is reflective, facilitating use during a walk. FIG. 1 shows the rear binding 100 that faces toward the dog's rear end, the front binding 102 which is slightly curved in words to allow a slight indentation across the neck of the dog, as well as side bindings 104 and 106. The side bindings 104 and 106 are also curved to fit around the dog's legs.

The material of the body 110 includes self lined foam material, which is breathable and washable material, allowing the dog's skin to breath.

FIG. 2 shows the top side of the harness, showing again the bindings 104, 106 from above, and showing how the openings near the bindings curve to conform to the legs of the dog. In addition, the harness is substantially open at the center section 200, and has overlapping sections 201, 202 that extend across the top of the dog's body to hold the top part of the harness on the dog, so that the harness does not fall off the dog. The two extending sections 201, 202 are held together and in place by a webbing that extends between the first side 210 and the second side 212. The webbing 220 includes a D-ring 221, and a clip 223 which clips between the sides to hold them together. Once clipped, the harness is held to the dog, and the clip is adjustable for tightness. Then, once the clip is held to the dog, the D-ring 221 can be used to attach a leash. The clip can be opened to remove the harness from the dog. The webbing 220 holds the first extending section to the second extending section and also allows disconnection between the first extending section and the second extending section,

The top part also includes a closable attachment pouch 230 which is shown in further detail in FIG. 3. The attachment pouch 230 is attached in a sideways direction to the surface 240 of the body so that the top of the pouch opens and closes in a direction parallel to the plane of the body. That is, the buying the pocket has a closure which opens in the direction shown as 300, while hinging on a section 302 of the pocket. Items can be loaded into the pocket, including waste bags. The pocket also includes an opening 310, which according to an embodiment can be a ¼ inch slit or ½ inch slit. When the waste bags have been loaded into the pocket, the user can push their finger through the opening 310 with a waste bag thereon, so that a little part of the waste bag extends from the pocket. This makes it easy to remove a waste bag without opening the top portion 312. The top portion 320 closes with a Velcro closure 325 against the side of the pocket, where that side surface of the pocket which holds the Velcro closed is perpendicular to the surface 240 on which the pocket is mounted.

The waste bags can be removed without opening the pocket, thus facilitating getting a waste bag out of the pocket, and also facilitating that items which are stored in the pocket such as keys or identification cannot fall out of the pocket while the user is taking the waste bag out of the pocket.

Moreover, since the pocket opens by hinging in a direction parallel to the plane on which the pocket is mounted, the items which are placed in the pocket are less likely to come out of the pocket, since they are not pressing against the direction of opening of the pocket. In one embodiment, the pocket can be 1½ inches in width which extends above the surface of the body, and 3½ inches in length, in the direction parallel to the body. The device can be of different sizes to port support different sized dogs.

In another embodiment, a box of waste bags can be loaded so that when one is removed, a piece of the next one also extends through the slit. The box can be loaded into the pocket, and the bag extended through its slot.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A dog harness, comprising:
a main body, formed of a material having a front section, a back section, a first leg opening, and a second leg opening,
the first and second leg openings extending between a bottom portion of the main body, and a top portion of the main body,
the bottom portion of the main body connected between the first and second openings,
and the top portion of the main body having a center opening, a first extending section overlapping with a second extending section and separable from said second extending section, and a connection section, which connects between the first extending section and the second extending section and holding the first extending section relative to the second extending section and also allowing disconnection between the first extending section and the second extending section,
a pocket, the pocket extending above a surface of the first extending section, and having an interior cavity, and the pocket having a slot at a top section thereof, the slot being effective to allow dispensing dog waste bags through a surface of the pocket.

2. The harness as in claim 1, wherein the slot is a ½ inch long slot.

3. The harness as in claim 1, wherein the connection section also includes a D-ring attached thereto allowing attaching a leash to the D-ring.

4. The harness as in claim 1, wherein the pocket includes a having a closure mechanism that hinges a pocket top section on a pocket body, the pocket body mounted on the first extending section, extending along a surface of the first extending section, and where the slot enables dispensing dog waste bags without opening the pocket.

5. The harness as in claim 4, wherein the cover hinges in a direction where the axis of hinging is perpendicular to a surface of the first extending section, so that the cover hinges parallel to the surface of the first extending section.

6. The harness as in claim 5, wherein the pocket closes using a Velcro closure.

7. The harness as in claim 3, wherein the D-ring is formed of webbing material attached to the first extending section and the second extending section, and attached between the first extending section and the second extending section.

8. The harness as in claim 1, wherein each of the first and second leg openings includes a reinforcement binding thereon.

9. A method of operating a dog harness, comprising:
placing a main body, formed of a material having a front section, a back section, a first leg opening, and a second leg opening, on a dog, where the first and second leg openings extending between a bottom portion of the main body, and a top portion of the main body, the bottom portion of the main body connected between the first and second openings, and the top portion of the main body having a center opening, a first extending section overlapping with a second extending section and separable from said second extending section, and a connection section, which connects between the first extending section and the second extending section and holding the first extending section relative to the second extending section and also allowing disconnection between the first extending section and the second extending section,
placing waste bags into a pocket that extends above the main body, the pocket extending above a surface of the first extending section, and having an interior cavity, and the pocket having a slot at a top section thereof, the slot being effective to allow dispensing dog waste bags through a surface of the pocket;
closing the pocket using a closure; and
removing a waste bag from the pocket without opening the closure.

10. The method as in claim 9, wherein the slot is a ½ inch long slot.

11. The method as in claim 9, wherein the connection section also includes a D-ring attached thereto allowing attaching a leash to the D-ring.

12. The method as in claim 9, wherein the cover hinges in a direction where the axis of hinging is perpendicular to a surface of the first extending section, so that the cover hinges parallel to the surface of the first extending section.

13. The method as in claim 12, wherein the pocket closes using a Velcro closure.
